(19) United States
(12) Patent Application Publication
(10) Pub. No.: US 2010/0000290 A1
(43) Pub. Date: Jan. 7, 2010

(54) GAS SENSOR MOUNTING STRUCTURE

(76) Inventor: Yoichiro Goya, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/374,813

(22) PCT Filed: Jul. 23, 2007
(86) PCT No.: PCT/IB2007/002075

§ 371 Date: Jan. 23, 2009

(30) Foreign Application Priority Data
Jul. 24, 2006 (JP) 2006-201154

(51) Int. Cl. G01N 7/00

(52) U.S. Cl. 73/23.31

(57) ABSTRACT

A gas sensor mounting structure (10) is provided for mounting a gas sensor (1) that has a gas sensor element (2) and a sensor cover (3) covering the gas sensor element (2), in an exhaust manifold (5). The gas sensor (1) is mounted in the exhaust manifold (5) at such an angle with respect to the gas flow direction in the exhaust manifold (5) that makes it difficult for water present in the exhaust manifold (5) to come in contact with the gas sensor element (2). Also, the gas sensor (1) is mounted in the exhaust manifold (5) such that an axis (P) of the gas sensor (1) is not generally perpendicular to the exhaust manifold (5) at the mounting position. In addition, the gas sensor (1) is mounted immediately after a bend (R) in the exhaust manifold (5).

### BACKGROUND OF THE INVENTION

1. Field of the Invention

The present invention relates to a gas sensor mounting structure, and in particular to a gas sensor mounting structure for mounting a gas sensor in an intake or exhaust passage of an internal combustion engine.

2. Description of the Related Art

Typically, gas sensors such as oxygen sensors, air-fuel ratio sensors, NOx sensors, and HC sensors are mounted in the intake or the exhaust gas passage of an internal combustion engine. FIG. 3 schematically shows a detection portion in a common gas sensor 1. The common gas sensor 1 has a cylindrical housing 4, a gas sensor element 2 that is inserted and fixed to the housing 4, and a sensor cover 3 that covers the gas sensor element 2. The sensor cover 3 includes an inner cover 3a and an outer cover 3b. The inner cover 3a and the outer cover 3b are each formed with gas communication holes H, which are positioned so as not to overlap each other. Thus, the inner cover 3a prevents the exposure of the gas sensor element 2 to water, such as condensed water that enters through the gas communication holes H of the outer cover 3b. In view of the possibility of the gas sensor element exposed to water and the response of the gas sensor, sensor covers of various shapes and structures have been proposed in JP-A-2003-75396, JP-A-2004-245828, and JP-A-2004-294299.

Measures to prevent exposing a gas sensor element to water are generally based on the assumption that the gas sensor is mounted generally perpendicular to the intake or the exhaust gas passage, and on the assumption that the gas sensor thus mounted is also perpendicular to a flow direction of gas to be measured. On the other hand, the mounting position of the gas sensor is determined in consideration of the uniformity in concentration of the gas, the mountability and maintainability of the gas sensor, at that position. In the case where the gas sensor is mounted generally perpendicular to the intake or exhaust gas passage, however, the gas sensor may be not always perpendicular to the gas flow direction. FIG. 4 schematically shows a gas sensor mounting structure (which may hereinafter be simply referred to as “mounting structure”). To be specific, FIG. 4 shows a gas sensor mounting structure in which the gas sensor 1 is mounted at an angle of approximately 90° relative to an exhaust manifold 5 (i.e., the exhaust gas passage). FIG. 4 shows gas sensor mounting structures 10Xa, 10Xb and 10Xc in which the gas sensor 1 is mounted at three mounting positions A, B and C, respectively, for comparison. A catalytic converter 6 is connected downstream of the exhaust manifold 5.

The mounting structures 10Xa, 10Xb and 10Xc include the exhaust manifold 5 and the gas sensor 1 that is mounted in the exhaust manifold 5 in such a way as shown in FIG. 4. In all of the mounting structures 10Xa, 10Xb and 10Xc, the gas sensor 1 is mounted in a part of the exhaust manifold 5 where pipes from respective cylinders have been merged together. The mounting position A is defined immediately after a bend R in the gas passage of the exhaust manifold 5, the mounting position B is defined at an entry to the bend R in the gas passage, and the mounting position C is defined further downstream from the mounting position A. Thus, an axis P of the gas sensor 1 and the flow direction of exhaust gas are generally perpendicular to each other with the mounting structures 10Xb and 10Xc, while they make an obtuse angle with the mounting structure 10Xa.

FIGS. 5A to 5C show the results of water injection tests conducted to determine whether the gas sensor element 2 would be exposed to water with the gas sensor mounting structures 10Xa, 10Xb and 10Xc, respectively. The water injection tests were conducted by injecting water in an amount of 100 cc from upstream of the exhaust manifold 5 while operating an internal combustion engine (not shown) that incorporates the gas sensor mounting structures 10Xa, 10Xb and 10Xc at 2000 rpm on a stand, in order to determine whether water would come into contact with the gas sensor element 2. FIG. 5D schematically shows how the water was injected. The amount of water injected in the water injection tests was substantially larger than the amount of condensed water that would actually be produced. In the water injection tests, temperature sensors were provided to each of the gas sensor element 2, the inner cover 3a and the outer cover 3b to examine the possibility of the gas sensor element 2 exposed to water, based on how their temperatures decreased. As can be seen from the test results with the mounting structures 10Xa, 10Xb and 10Xc shown in FIGS. 5A, 5B and 5C, respectively, the temperatures of the inner cover 3a and the outer cover 3b drastically decreased after the water injection. Also, it can be seen that with the mounting structures 10Xb and 10Xc, the temperature of the gas sensor element 2 gently decreased after the water injection. On the other hand, it can be seen that with the mounting structure 10Xa shown in FIG. 5A, the temperature of the element drastically decreased after the water injection. From the above, it can be presumed that with the mounting structure 10Xa the gas sensor element 2 has come in contact with water.

That is, because protection measures, etc., for a gas sensor are based on the above assumptions, the gas sensor makes an obtuse angle relative to the gas flow direction as shown in FIG. 5E in the case where the gas sensor is mounted generally perpendicular to the intake or exhaust gas passage, for example at mounting position A, which unfavorably permits a gas sensor element to easily come in contact with water and might consequently crack the gas sensor element.

### SUMMARY OF THE INVENTION

The present invention provides a gas sensor mounting structure that may prevents exposure of a gas sensor element to water.

A first aspect of the present invention relates to a gas sensor mounting structure for mounting a gas sensor having a gas sensor element and a sensor cover in a gas passage. The sensor cover has at least a double structure including an inner cover that directly covers the gas sensor element and an outer cover that is directly exposed to a flow of gas. The gas sensor is mounted in the gas passage at such an angle with respect to the gas flow direction in the gas passage that makes it difficult for water present in the gas to come in contact with the gas sensor element. According to the present invention, the gas sensor is mounted in consideration of the gas flow direction, rather than being mounted generally perpendicular to the axis of the gas passage due to the mounting convenience. Thus, exposure of the gas sensor element to water may be prevented.

As with the first aspect, a second aspect of the present invention relates to a gas sensor mounting structure for mounting a gas sensor having a gas sensor element and a sensor cover in a gas passage. The sensor cover has at least a double structure including an inner cover that directly covers the gas sensor element and an outer cover that is directly exposed to a flow of gas. The gas sensor is mounted in the gas passage such that the angle between a gas flow direction in the gas passage and a gas flow direction between the outer cover and the inner cover is approximately 90° or less.

In general, exposure of the gas sensor element to water may be prevented by mounting the gas sensor with its axis generally perpendicular to the axis of the gas passage in the case where the gas in the gas passage flows generally perpendicular to the gas sensor. Thus, it is difficult for water to reach the gas sensor element if the gas flow direction in the gas passage and the axis of the gas sensor makes an angle of approximately 90° or an acute angle. This is because the gas communication hole H of the outer cover is in general formed closer to the distal end than the gas communication hole H of the inner cover as shown in FIG. 3, and thus if the axis of the gas sensor makes an obtuse angle relative to the gas flow direction, water can easily enter the gas communication hole formed in the inner cover. On the other hand, if the mounting angle is an acute angle, it is accordingly difficult for water to enter the gas communication hole formed in the inner cover. In the case of an acute angle, however, the mounting angle should also be determined in consideration of the responsiveness in detecting the gas as well.

The gas sensor may be mounted in the gas passage such that an axis of the gas sensor is not generally perpendicular to the axis of the gas passage at the mounting position.

The gas sensor may be mounted at or immediately after a bend in the gas passage. To be more specific, a suitable water blocking effect may be achieved by mounting the gas sensor at or immediately after a bend in the gas passage as in the present invention, for example.

At least one of the inner cover and the outer cover of the sensor cover may be formed with an additional gas communication hole. The additional gas communication hole of the sensor cover in the mounted state is open downward a plumb line. Providing the additional gas communication hole such as in the present invention prevents condensed water from collecting in the sensor cover and consequently prevents the gas sensor element from being exposed to the water.

The gas sensor may be mounted in an exhaust gas passage in an internal combustion engine. In particular, the gas sensor may be mounted in an exhaust manifold.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1A schematically shows a gas sensor mounting structure in accordance with an example embodiment of the present invention;

FIG. 1B shows a gas sensor mounting structure as a comparative example of FIG. 1A;

FIG. 1C schematically illustrates the water blocking effect for a gas sensor according to the example embodiment;

FIG. 2 schematically shows the results of water injection tests conducted on the gas sensor mounting structures in accordance with the example embodiment of the present invention and the comparative example;

FIG. 3 schematically shows a detection part of a gas sensor 1 in accordance with the example embodiment of the present invention;

FIG. 4 schematically shows gas sensor mounting structures at three mounting positions as comparative examples of the present invention;

FIG. 5A schematically shows the results of a water injection test conducted on the gas sensor mounting structure at a mounting position A as the comparative example of the present invention;

FIG. 5B schematically shows the results of a water injection test conducted on the gas sensor mounting structure at a mounting position B;

FIG. 5C schematically shows the results of a water injection test conducted on the gas sensor mounting structure at a mounting position C;

FIG. 5D schematically shows how water was injected in the water injection tests of FIGS. 5A to 5C; and

FIG. 5E schematically illustrates how the gas sensor at the mounting position A according to the comparative example comes into contact with water.

### DETAILED DESCRIPTION OF THE PREFERRED EMBODIMENTS

An example embodiment of the present invention will be described in detail below with reference to the drawings.

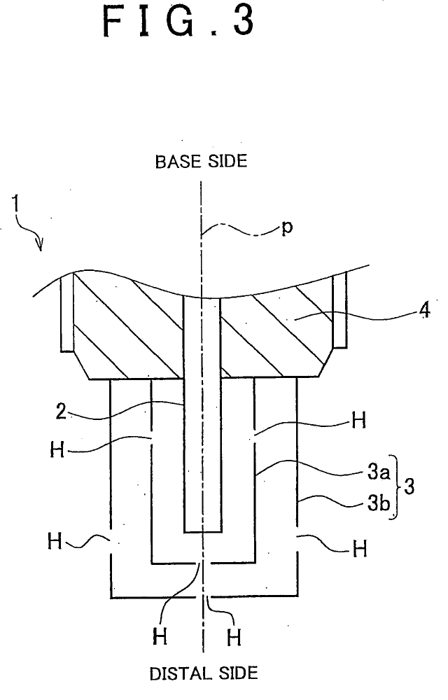

A detection part of a gas sensor 1 according to the example embodiment is described in detail with reference to FIG. 3. The gas sensor 1 according to the example embodiment is an air-fuel ratio sensor that linearly detects the air-fuel ratio based on the oxygen concentration in the exhaust gas. The gas sensor 1 is not limited thereto, and may be an oxygen sensor that detects whether the air-fuel ratio is richer or leaner than the stoichiometric air-fuel ratio based on the oxygen concentration in exhaust gas, or various types of gas sensors for measuring NOx concentration, CO concentration, HC concentration, or other gases. The gas sensor 1 includes a laminated type gas sensor element 2. Alternatively, a cup-shaped gas sensor element may be provided. A sensor cover 3 has a double structure including an inner cover 3a that directly covers the gas sensor element 2 and an outer cover 3b that is directly exposed to a flow of exhaust gas. Alternatively, instead of the sensor cover 3, a sensor cover having a triple or more structure may be provided.

The inner cover 3a and the outer cover 3b are both in the form of a cylinder having a bottom at its distal end. The inner cover 3a and the outer cover 3b are not limited thereto, and the distal end of at least one of the inner cover 3a and the outer cover 3b may be open. Also, the cross sectional shape of the inner cover 3a and the outer cover 3b may be elliptical rather than circular, and the cross sectional area may be non-uniform from the base end to the distal end. At least one gas communication hole H is formed in the side surface of each of the inner cover 3a and the outer cover 3b. An additional gas communication hole H is formed in the bottom of each of the inner cover 3a and the outer cover 3b. The number, arrangement, shape, size, etc., of the gas communication holes H are not specifically limited, and may be determined appropriately as long as an axis P of the gas sensor 1 and the flow direction of exhaust gas are generally perpendicular to each other and water is blocked from contacting the gas sensor element 2. The inner cover 3a and the outer cover 3b are each fixed to a housing 4 by crimping with their axes generally identical with the axis P of the gas sensor 1.

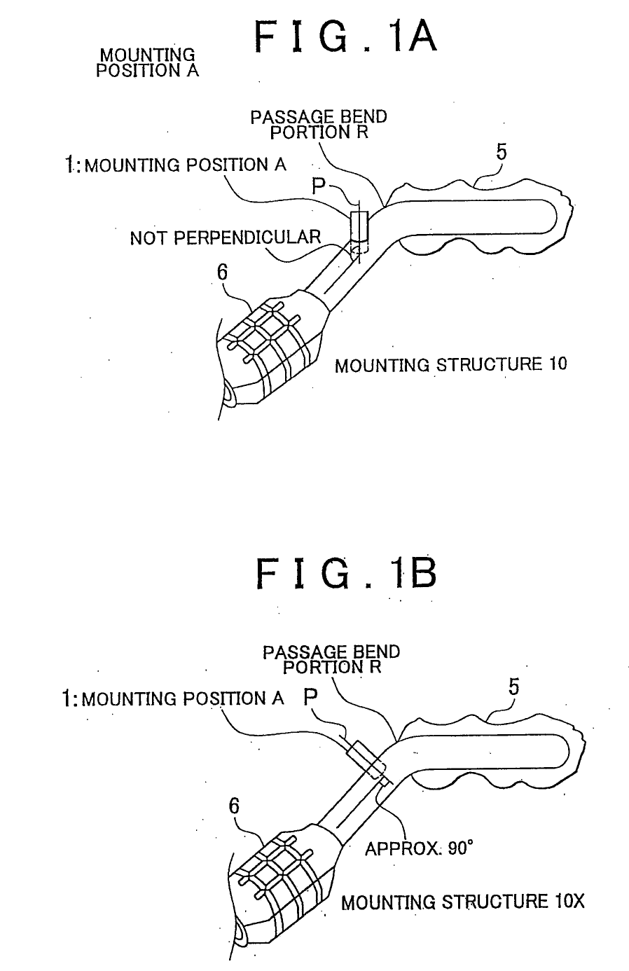

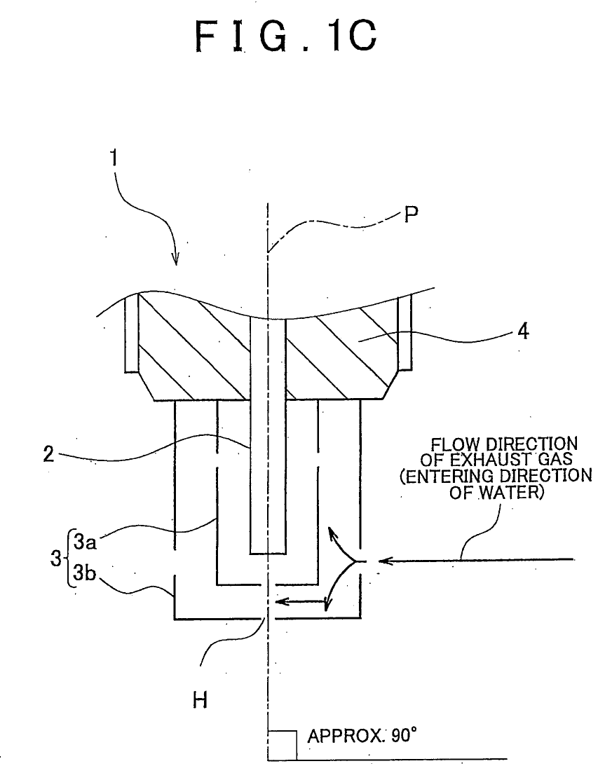

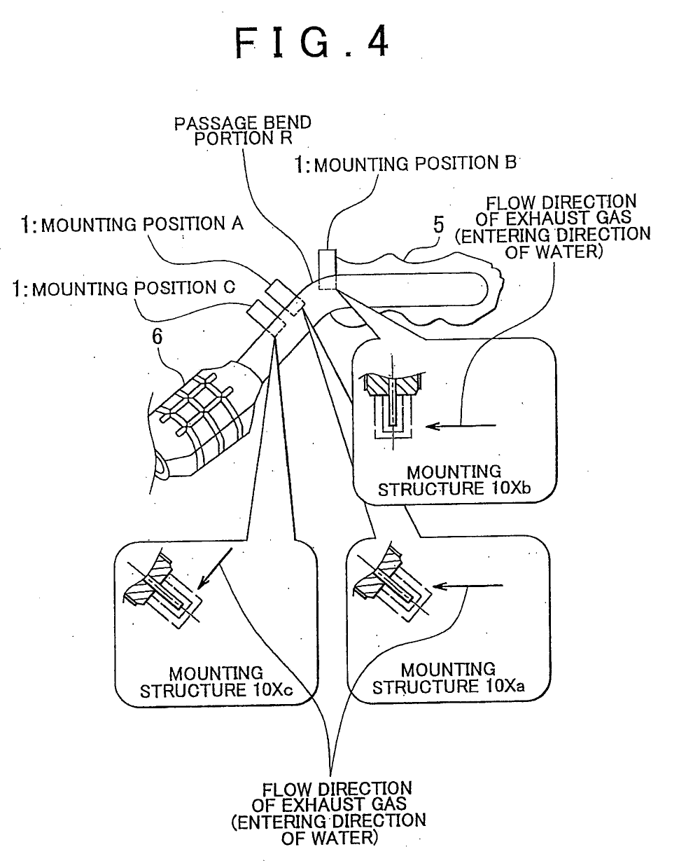

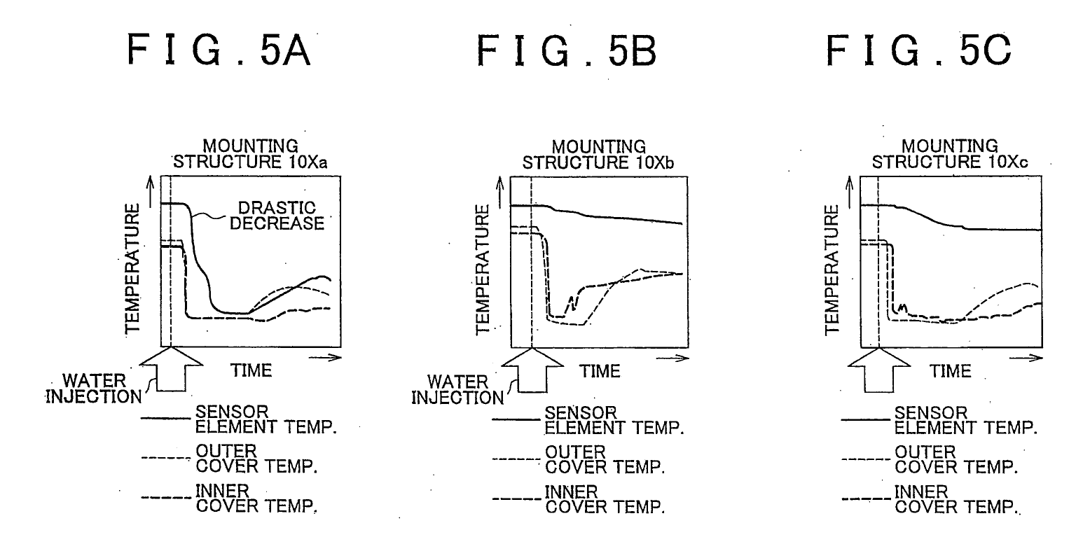

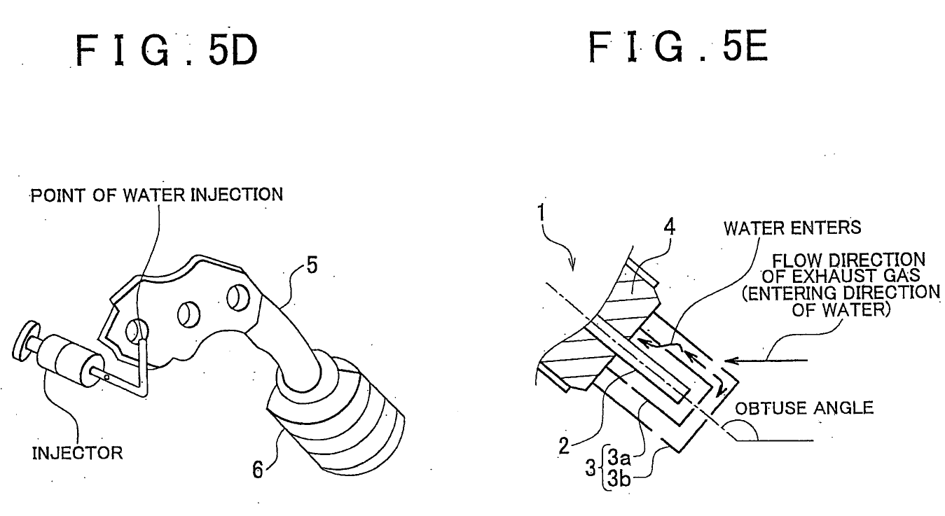

FIGS. 1A to 1C schematically show a gas sensor mounting structure 10 in accordance with the example embodiment. To be specific, FIG. 1A shows a gas sensor mounting structure 10 in accordance with the example embodiment, and FIG. 1B shows a gas sensor mounting structure 10X as a comparative example. FIG. 1C schematically illustrates how water is blocked from the gas sensor 1 according to the example embodiment. The gas sensor mounting structure 10X of FIG. 1B is the same as that at the mounting position A shown in FIG. 4. The gas sensor mounting structure 10 in the example embodiment includes an exhaust manifold 5 and the gas sensor 1 that is mounted in the exhaust manifold 5 in such a way as shown in FIG. 1A. Here, the exhaust manifold 5 may be regarded as the “gas passage” of the present invention. In both of the mounting structures 10 and 10X the gas sensor 1 is mounted in a part of the exhaust manifold 5 where pipes from respective cylinders have been merged together. Also, in both of the mounting structures 10 and 10X, a bend R in the gas passage is provided before the mounting position A for the gas sensor 1. In other words, the gas sensor 1 is mounted immediately after the bend R in the gas passage.

The exhaust manifold 5 includes a boss (not shown) for mounting the gas sensor 1. The boss is welded to the exhaust manifold 5. In the mounting structure 10 shown in FIG. 1A, the seating surface of the boss is formed such that with the gas sensor 1 mounted on the seating surface, the axis P of the gas sensor 1 and the gas flow direction are generally perpendicular to each other. Also, the seating surface of the boss is formed obliquely such that the axis P of the gas sensor 1 and the axis of the exhaust manifold 5 are not generally perpendicular to each other at the mounting position. A threaded hole for mounting the gas sensor 1 is formed to penetrate through the boss and to extend generally perpendicular to the seating surface of the boss. Meanwhile, the sensor cover 3 is formed to block water form the gas sensor element 2, with the axis P of the gas sensor 1 generally perpendicular to the flow direction of exhaust gas as shown in FIG. 1C. In this way, in the mounting structure 10 shown in FIG. 1A, the gas sensor 1 is mounted in the exhaust manifold 5 at such an angle with respect to the gas flow direction in the exhaust manifold 5 that makes it difficult for water present in the exhaust gas to come in contact with the gas sensor element 2. That is, the gas sensor 1 is mounted in the exhaust manifold 5 at an angle such that the gas flow direction in the exhaust manifold 5 generally perpendicular to the flow direction of exhaust gas between the outer cover 3b and the inner cover 3a of the gas sensor 1. To be specific, the gas sensor 1 is mounted in the exhaust manifold 5 at such an angle that makes the axis P of the gas sensor 1 generally perpendicular to the flow direction of the exhaust gas, and that does not make the axis P of the gas sensor 1 generally perpendicular to the axis of the exhaust manifold 5.

On the other hand, in the mounting structure 10X as a comparative example shown in FIG. 1B, the seating surface of the boss is formed such that with the gas sensor 1 mounted on the seating surface, the axis P of the gas sensor 1 and the axis of exhaust manifold 5 are generally perpendicular to each other. In this way, the gas sensor 1 is mounted such that the axis P of the gas sensor 1 and the axis of exhaust manifold 5 are generally perpendicular to each other at the mounting position. With the mounting positions shown in FIGS. 1A and 1B, however, the flow of the exhaust gas does not necessarily follow the shape of the gas passage, because the exhaust gas would flow straight until the exhaust gas hits the inner wall of the bend R in the gas passage. Thus, with the mounting structure 10X shown in FIG. 1B, the axis P of the gas sensor 1 and the flow direction of exhaust gas make an obtuse angle, which is more likely to allow condensed water together with exhaust gas to come in contact with the gas sensor element 2, thereby cracking the gas sensor element 2.

In contrast, with the mounting structure 10 shown in FIG. 1A, the axis P of the gas sensor 1 and the gas flow direction are generally perpendicular to each other. Thus, exhaust gas and condensed water that have passed through the gas communication hole H of the outer cover 3b hit the inner cover 3a and are separated as shown in FIG. 1C. In addition, in the example embodiment, condensed water does not remain in the gas sensor 1, but is drained through the additional gas communication hole H that is also formed in the bottom of the sensor cover 3 (specifically each of the inner cover 3a and the outer cover 3b). Thus, with the mounting structure 10 shown in FIG. 1A, it is possible to prevent the gas sensor element 2 from coming into contact with water.

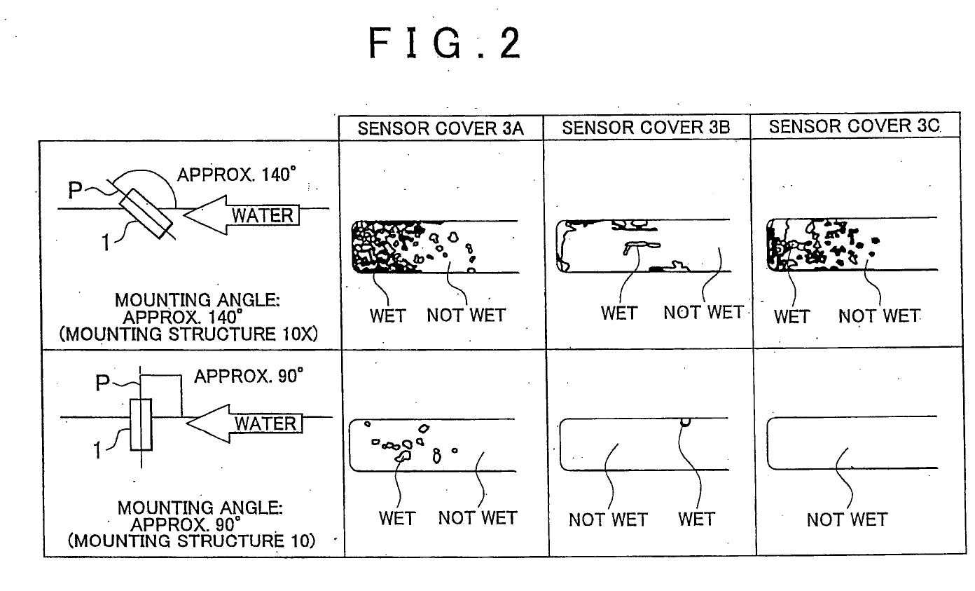

FIG. 2 schematically shows the results of water injection tests conducted on the mounting structures 10 and 10X. The water injection tests were conducted by injecting 100 cc of water from upstream of the exhaust manifold 5 while operating an internal combustion engine (not shown), mounted on a stand, that incorporates the gas sensor mounting structures 10 and 10X at 2000 rpm in order to determine whether water would come into contact with the gas sensor element 2. The amount of water injected was substantially larger than the amount of condensed water that would actually be produced. The water injection tests were conducted using three types of sensor covers 3A, 3B and 3C of different shapes. The sensor cover 3A is the basic type among the sensor covers. The sensor cover 3B is adapted to more effectively prevent the water from contacting the gas sensor element 2 than the sensor cover 3A when the gas sensor 1 is mounted at an angle of approximately 140° relative to the flow direction of exhaust gas. The sensor cover 3C is adapted to more effectively prevent the water from contacting the gas sensor element 2 than the sensor cover 3A when the gas sensor 1 is mounted at an angle of approximately 90° relative to the flow direction of exhaust gas.

The test results with the gas sensor 1 mounted at an obtuse angle of approximately 140° relative to the flow direction of exhaust gas showed that with the sensor covers 3A and 3C, the gas sensor element 2 came into contact with significant amounts of water. This is because the gas sensor 1 is mounted at an obtuse angle relative to the flow direction of exhaust gas, which permits water to easily reach the gas sensor element 2. On the other hand, with the sensor cover 3B, which is designed to more effectively prevent the water from contacting the gas sensor element 2 at an obtuse mounting angle of approximately 140°, the gas sensor element 2 did not come into contact with water. The test results with the gas sensor 1 mounted at an angle of approximately 90° relative to the flow direction of exhaust gas showed that with all of the sensor covers 3A, 3B and 3C, progressively reduced the amount of water came into contact with the gas sensor element 2. Especially, with sensor cover 3C, in which no water came into contact with the gas sensor element 2.

As can be seen from these test results, according to the gas sensor mounting structure 10, it is possible to effectively prevent the water from coming into contact with the gas sensor element 2 using a conventional gas sensor 1, even in the case where the gas sensor 1 is mounted immediately after the bend R in the gas passage. Also, instead of a conventional gas sensor 1, a gas sensor with an improved sensor cover 3 may be used to more effectively prevent the water from coming into contact with the gas sensor element 2. In the above description of the example embodiment, the gas sensor 1 is mounted at an angle of approximately 90° relative to the flow direction of exhaust gas. However, the gas sensor 1 may be mounted at an acute angle relative to the flow direction of exhaust gas. In this case, because it is generally difficult for the exhaust gas to reach the gas sensor element 2, it is preferable to determine the mounting angle in consideration of the responsiveness of the gas sensor 1 as well. The gas sensor mounting structure 10 may be applied not only when the gas sensor 1 is mounted immediately after the bend R in the gas passage, but also when the gas sensor 1 is mounted at the bend R in the gas passage with modification. As has been described above, the gas sensor mounting structure 10 prevents the gas sensor element 2 from getting exposed to water.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1.-11. (canceled)

12. A gas sensor mounting structure comprising:
a gas sensor that has a gas sensor element and a sensor cover, the sensor cover having at least a double structure that includes an inner cover which directly covers the gas sensor element and an outer cover which is directly exposed to a flow of gas, the gas sensor being mounted in a gas passage at such an angle with respect to a gas flow direction in the gas passage that makes a longitudinal axis of the gas sensor generally perpendicular to the flow direction of the gas so that it is difficult for water present in the gas to come in contact with the gas sensor element.

13. A gas sensor mounting structure comprising:
a gas sensor that has a gas sensor element and a sensor cover, the sensor cover having at least a double structure that includes an inner cover which directly covers the gas sensor element and an outer cover which is directly exposed to a flow of gas, the gas sensor being mounted in a gas passage such that an angle between a flow direction of gas in the gas passage and a flow direction of gas present between the outer cover and the inner cover is approximately 90° or less.

14. The gas sensor mounting structure according to claim 12, wherein a communication hole to allow entry of the gas from the gas passage into the sensor cover is formed in a side surface of each of the inner cover and the outer cover.

15. The gas sensor mounting structure according to claim 13, wherein a communication hole to allow entry of the gas from the gas passage into the sensor cover is formed in a side surface of each of the inner cover and the outer cover.

16. The gas sensor mounting structure according to claim 12, wherein the gas sensor is mounted in the gas passage such that a longitudinal axis of the gas sensor is not generally perpendicular to the axis of the gas passage at the mounting position.

17. The gas sensor mounting structure according to claim 13, wherein the gas sensor is mounted in the gas passage such that a longitudinal axis of the gas sensor is not generally perpendicular to the axis of the gas passage at the mounting position.

18. The gas sensor mounting structure according to claim 12, wherein the gas sensor is mounted at a bend side in the gas passage.

19. The gas sensor mounting structure according to claim 13, wherein the gas sensor is mounted at a bend side in the gas passage.

20. The gas sensor mounting structure according to claim 18, wherein the gas sensor is mounted immediately after the bend in the gas passage.

21. The gas sensor mounting structure according to claim 19, wherein the gas sensor is mounted immediately after the bend in the gas passage.

22. The gas sensor mounting structure according to claim 12, wherein at least one of the inner cover and the outer cover of the sensor cover is formed with an additional gas communication hole that is open downward a plumb line in the mounted state of the gas sensor.

23. The gas sensor mounting structure according to claim 13, wherein at least one of the inner cover and the outer cover of the sensor cover is formed with an additional gas communication hole that is open downward a plumb line in the mounted state of the gas sensor.

24. The gas sensor mounting structure according to claim 12, wherein the gas sensor is mounted in an exhaust gas passage in an internal combustion engine.

25. The gas sensor mounting structure according to claim 13, wherein the gas sensor is mounted in an exhaust gas passage in an internal combustion engine.

26. The gas sensor mounting structure according to claim 24, wherein the gas sensor is mounted in an exhaust manifold.

27. The gas sensor mounting structure according to claim 25, wherein the gas sensor is mounted in an exhaust manifold.
